(19) United States
(12) Patent Application Publication
(10) Pub. No.: US 2014/0132523 A1
(43) Pub. Date: May 15, 2014

(54) Touch Sensing Based On Signal Reflections

(71) Applicants: David Brent Guard, Southampton (GB); Tsung-Ching Wu, Staratoga, CA (US); Esat Yilmaz, Santa Cruz, CA (US)

(72) Inventors: David Brent Guard, Southampton (GB); Tsung-Ching Wu, Staratoga, CA (US); Esat Yilmaz, Santa Cruz, CA (US)

(21) Appl. No.: 13/675,724

(22) Filed: Nov. 13, 2012

(51) Int. Cl. G06F 3/041

(52) U.S. Cl. CPC G06F 3/041
USPC 345/173; 178/18.03

(57) ABSTRACT

In one embodiment, a method performed by executing logic embodied by one or more computer-readable non-transitory storage media includes sending a first signal on a first line of a touch sensor. The first line includes a first plurality of electrodes. The method includes receiving a reflection of the first signal on the first line of the touch sensor. The method also includes determining coordinates of a touch on a device comprising the touch sensor in response to receiving the reflection of the first signal.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

Conventional touch sensors suffer from various problems. Given practical limits on touch sensor electrode spacing, the area available for routing of the sensor electrodes may limit the number of electrodes which can be used in a given sensor, thus limiting the resolution of touch position determination. The area available for electrical coupling of the touch sensor to other components of the touch sensing system may limit the number of sensor electrode signals which can be used, imposing another limitation on the achievable resolution of touch position determination. Components and materials necessary for conventional touch sensors are expensive and impractical in certain situations.

### BRIEF DESCRIPTION OF THE DRAWINGS

Reference is now made to the following description taken in conjunction with the accompanying drawings, wherein like reference numbers represent like parts and which:

FIG. 1 illustrates an example touch sensor and example touch-sensor controller;

FIG. 2 illustrates an example method for using a reflection of a signal to detect one or more touches; and

FIGS. 3, 4, 5A-C, and 6A-B illustrate example layouts of electrodes on a touch sensor.

### DESCRIPTION OF EXAMPLE EMBODIMENTS

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of electrodes disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

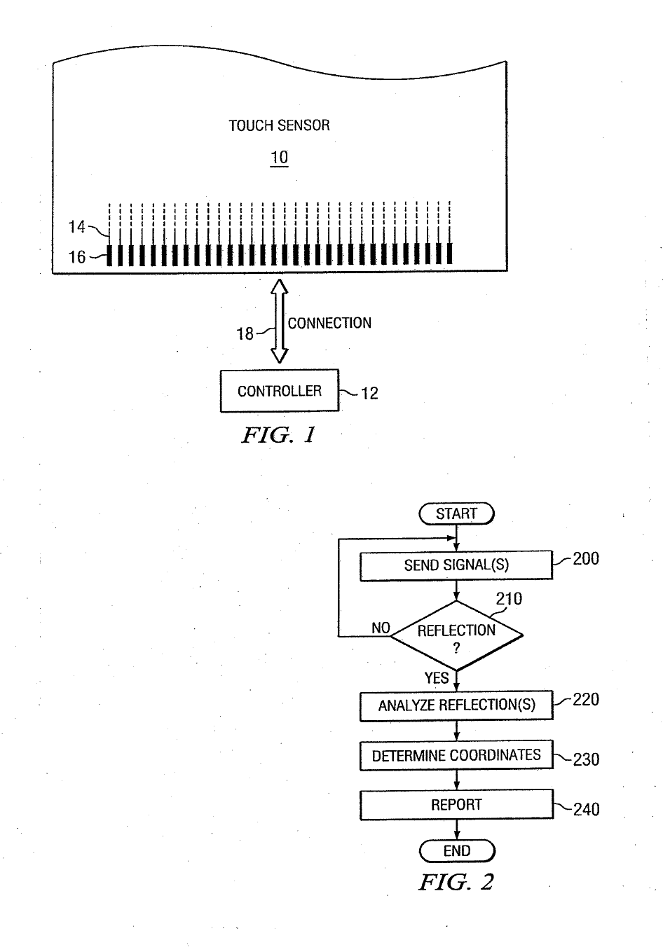

In some embodiments, touch sensor 10 may implement a form of touch sensing based on sensing signal reflections. Touch sensor 10 may include electrodes forming one or more lines. A signal (e.g., a pulse or a periodic signal) is applied to a line of touch sensor 10 (by touch-sensor controller 12), and a reflection of the signal applied to the line may be caused by an external influence (such as a touch or the proximity of an object). When an object touches or comes within proximity of the line, a change in impedance may occur at or near the location of the line where the touch or the approach of the object occurred. Touch-sensor controller 12 may measure a reflection of the signal present on the line that is caused by that change in impedance of the affected portion of the line. By measuring timing and other characteristics of the reflection, touch-sensor controller 12 may determine the position of the touch or proximity within the touch-sensitive area(s) of touch sensor 10. Further discussion of these embodiments and other embodiments are discussed below with respect to FIG. 2.

In particular embodiments, one or more electrodes may together form a line running horizontally and/or vertically or in any suitable orientation. In particular embodiments, one or more electrodes may run substantially perpendicular to other electrodes. A line may have a serpentine shape or may be configured as a space-filling curve. Herein, a line may encompass one or more electrodes making up the line, and vice versa, where appropriate.

Touch sensor 10 may have electrodes disposed in a pattern on one side of a single substrate. In addition or as an alternative, touch sensor 10 may have electrodes disposed in a pattern on another side of a substrate. Although this disclosure describes particular configurations of particular electrodes forming particular lines, this disclosure contemplates any suitable configuration of any suitable electrodes disposed on any suitable number of any suitable substrates in any suitable patterns.

As described above, a signal reflection at a line of touch sensor 10 may indicate a touch or proximity input. Touch-sensor controller 12 may detect and process the signal reflection to determine the presence and location of the touch or proximity input. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the electrodes of touch sensor 10. The sense unit may sense signal reflections from the electrodes of touch sensor 10 and provide measurement signals to the processor unit representing signal reflections. The processor unit may control the supply of drive signals to the electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide connections for coupling touch-sensor controller 12 to electrodes of touch sensor 10, through which the drive unit of touch-sensor controller 12 may supply drive signals to the electrodes. Tracks 14 may provide connections for coupling touch-sensor controller 12 to electrodes of touch sensor 10, through which the sense unit of touch-sensor controller 12 may sense signals from the electrodes of touch sensor 10. In some embodiments, one of tracks 14 may be configured such that it is used to both transmit drive signals from touch-sensor controller 12 to certain electrodes of touch sensor 10 and transmit signals from electrodes of touch sensor 10 to the sense unit of touch- sensor controller 12. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10. In some embodiments, touch sensor 10 may be configured to include pattern resistors, capacitors, and/or inductors (e.g., formed using FLM or other suitable material used in touch sensor 10) such that any of the interfaces (e.g., connection pads 16) between touch-sensor controller 12 and touch sensor 10 are impedance matched. For example, the pattern resistors, capacitors, and/or inductors may be configured to simulate BNC connectors (e.g., 50, 75, or 100 ohm connectors).

FIG. 2 illustrates an example method for using a reflection of a signal to detect one or more touches. Some embodiments may repeat the steps of the method of FIG. 2, where appropriate. Moreover, although this disclosure describes and illustrates particular steps of the method of FIG. 2 as occurring in a particular order, this disclosure contemplates any suitable steps of the method of FIG. 2 occurring in any suitable order. Furthermore, although this disclosure describes and illustrates particular components, devices, or systems carrying out particular steps of the methods of FIG. 2, this disclosure contemplates any suitable combination of any suitable components, devices, or systems carrying out any suitable steps of any of the methods of FIG. 2.

The method may start at step 200, where one or more signals may be sent on one or more electrodes of a touch sensor. For example, at this step one or more signals may be sent from touch-sensor controller 12 to electrodes forming lines of touch sensor 10 of FIG. 1. Any suitable signal(s) may be sent at this step such as a pulse signal, or a periodic signal, as examples. In some embodiments, it may be advantageous to have the ability to send various types of signals at this step because certain signals may be more suitable for a particular environment or configuration than other signals. For example, a signal more complicated than a pulse may be advantageous because it may be easier to distinguish a reflection of such a signal from noise, as is further discussed below. In some embodiments, signals are sent on multiple electrodes of the touch sensor at the same time. This may provide an advantage in that touches may be detected faster by decreasing the screen refresh rate. In some embodiments, signals are sent on multiple electrodes of the touch sensor in groups or consecutively.

At step 210, in some embodiments, it is determined whether one or more reflections on one or more electrodes of the touch sensor is detected. If a reflection is detected, step 220 is performed. If a reflection is not detected, step 200 is performed. For example, touch-sensor controller 12 may sense whether reflections are present on electrodes forming lines of touch sensor 10. In some embodiments, a reflection is detected by comparing signals received by a touch-sensor controller to the signals sent at step 200. A reflection may be expected to be similar to a signal sent at step 200. For example, a reflection may be modeled as a complex coefficient multiple of a signal sent at step 200. The coefficient may be equal to the difference between the impedance at the point of disturbance on the electrode(s) that caused the reflection and the characteristic impedance of the electrode(s) divided by the sum of the impedance at the point of disturbance and the characteristic impedance of the electrode(s). The impedances may be complex. As an example, if a received signal is complex multiple of a signal sent at step 200, it may be determined that a reflection has been detected. Time-domain reflectometry may be used to analyze whether a reflection has occurred.

In some embodiments, electrodes of the touch sensor may be viewed as a classical transmission line. A voltage introduced onto a set of electrodes of the touch sensor will require a finite time to travel down the electrode(s) to a point x. The phase of the voltage moving down the set of electrodes may lag behind the voltage when introduced by an amount β per unit length. Furthermore, the voltage may be attenuated by an amount a per unit length by the series resistance and shunt conductance of the set of electrodes. The phase shift and attenuation are defined by the propagation constant γ, where:

γ=α+jβ

The velocity at which the voltage travels down the set of electrodes can be defined in terms of β:

ν_{ρ}=w/β; w is the wavelength.

In some embodiments, when a set of electrodes includes different impedances, a wave traveling down the set of electrodes may generate a reflection wave at the point where the impedance changes within the set of electrodes. The impedance of a set of electrodes on a touch sensor may change in response to the presence of a touch. The magnitude of the steady-state sinusoidal voltage along a set of electrodes with different impedances varies periodically as a function of distance between a maximum and minimum value. This variation, called a standing wave, is caused by the phase relationship between incident and reflected waves. A reflection coefficient (ρ) may be defined as the difference between the impedance at the point of disturbance within the set of electrodes that caused the reflection and the characteristic impedance of the set of electrodes divided by the sum of the impedance at the point of disturbance and the characteristic impedance of the set of electrodes. The ratio of the maximum and minimum values of this voltage is called the voltage standing wave ratio, a, and is related to the reflection coefficient (ρ) by the following equation:

σ=(1+|ρ|)/(1−|ρ|)

The reflected wave is separated in time from the incident wave. This time may be used to determine where along the set of electrodes the change in impedance occurred. Letting D denote this length:

D=ν_{ρ}·(T/2) ; where v_{ρ} is the velocity of propagation and T is the transit time of signal from when the signal is introduced to the point when a change in impedance was encountered and back again.

At step 210, in some embodiments, statistical processing may be used in determine whether a reflection has been detected. For example, one or more thresholds may be used when comparing the received signals to the signals sent at step 200 to cause detection of a reflection with a desired probability of error. Noise models may be used at step 210 in various embodiments in order to account for the environment and configuration of the touch sensor.

In some embodiments, at step 210, differential analysis may be performed in order to detect a reflection. For example, a periodic signal may be constantly applied to a set of electrodes at step 200. If there is a reflection, then a disturbance to the periodic signal may be detected. In analyzing the disturbance, the periodic signal sent at step 200 may be subtracted from the values being analyzed at step 210 to determine whether the resulting difference corresponds to a reflection of the signal sent at step 200. In some embodiments, this may be advantageous in that it may provide for a manner of distinguishing noise from a reflection.

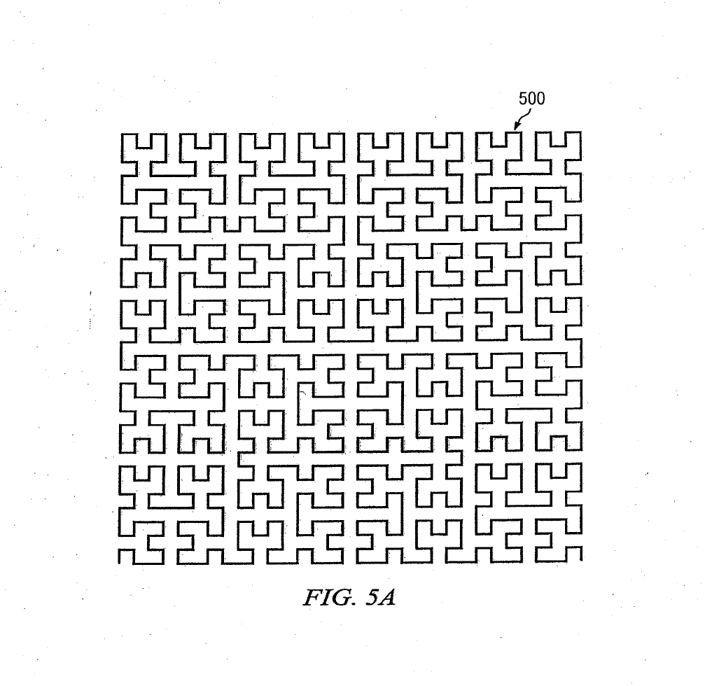

At step 220, in some embodiments, reflection(s) detected at step 210 are analyzed. Touch-sensor controller 12 of FIG. 1 may perform this step, as an example. One or more characteristics of the reflection(s) may be determined at step 220, such as the amplitude, magnitude, frequency, and/or phase of the reflection(s). It may also be determined when the reflection(s) were received in comparison to when the signal(s) were sent at step 200. Time-domain reflectometry may be used to analyze the reflection(s). One or more of the examples and techniques discussed above with respect to step 210 may be used at step 220. One or more of the techniques discussed in the examples below with respect to FIGS. 4-6B may be used at step 220. Other suitable analyses may be performed at step 220.

At step 230, in some embodiments, coordinates corresponding to one or more touches (or corresponding to a proximity to the touch sensor of one or more objects) may be determined. Touch-sensor controller 12 of FIG. 1 may perform this step, as an example. The characteristics determined at step 220 may be used in step 230. For example, the amplitude of a reflection and/or the amount of time that transpired between when the signal corresponding to the reflection was sent at step 200 and when the reflection was detected at step 210 may be used to determine where the reflection occurred within the set of electrodes of the touch sensor. Such analysis may be performed on each set of electrodes for which a reflection occurred if the touch sensor includes more than one set of electrodes. This information may be used to determine the coordinates of the touch. One or more of the techniques discussed in the examples below with respect to FIGS. 4-6B may be used at step 230.

At step 240, in some embodiments, the touch-sensor controller may report to a processor or other component of the device one or more of the results of the steps above, at which point the method may end. For example, the coordinates corresponding to the touch(es) detected are reported at this step.

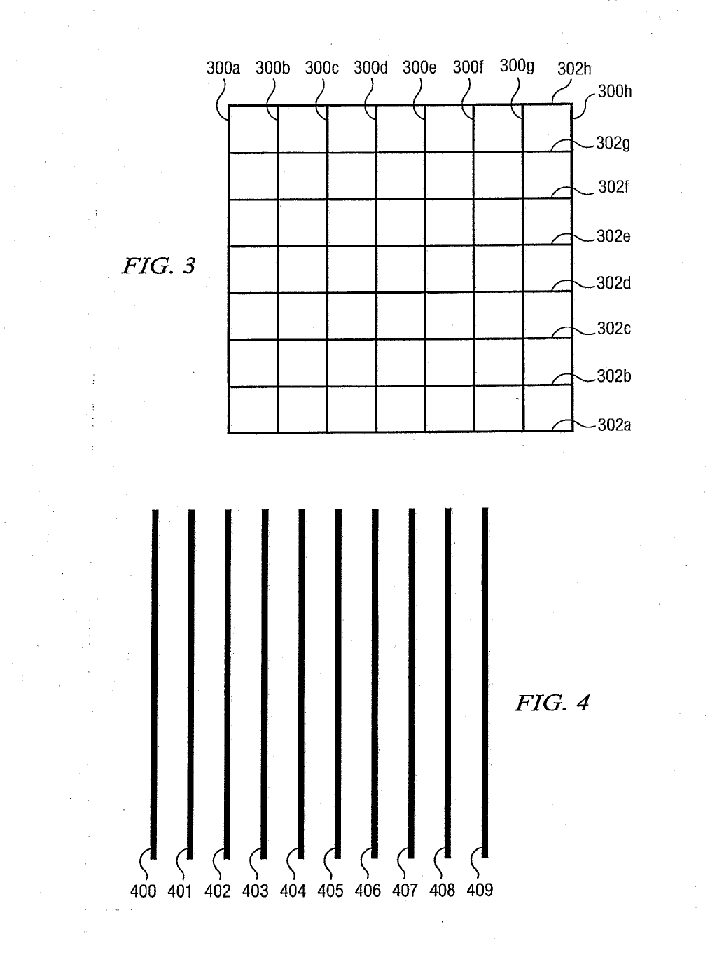

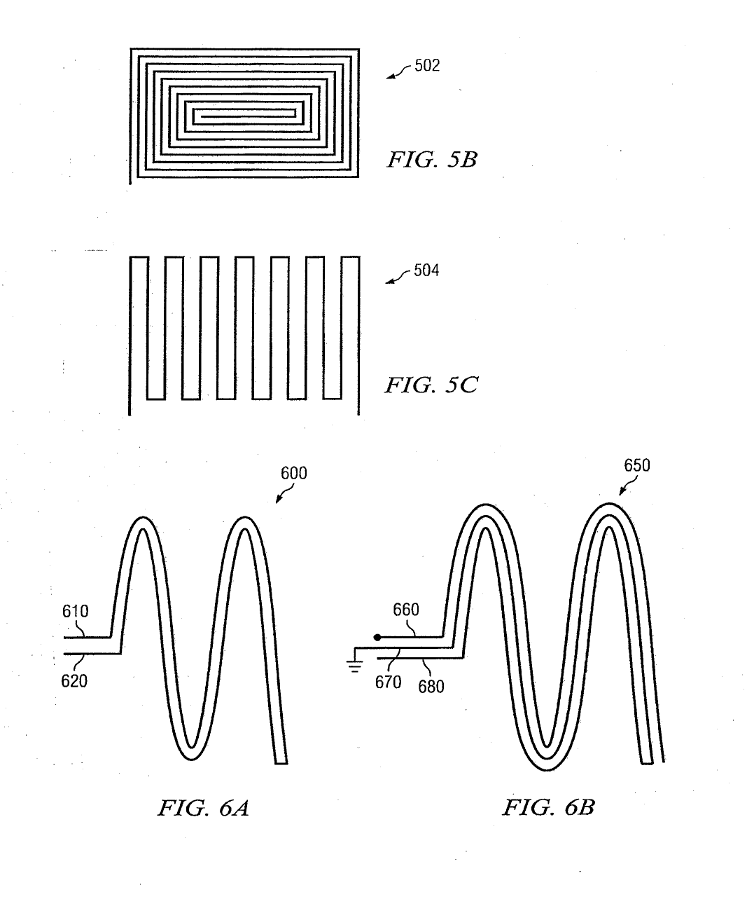

FIGS. 3, 4, 5A-C, and 6A-B are example layouts of electrodes formed by electrodes on touch sensor 10. Coordinates of touches on the layouts depicted on FIGS. 3, 4, 5A-C, and 6A-B may be determined using reflections. The examples discussed above with respect to FIGS. 1-2 as well as the examples discussed below may be used to detect touches on the layouts of FIGS. 3, 4, 5A-C, and 6A-B. Alterations and permutations to the layouts of FIGS. 3, 4, 5A-C, and 6A-B are contemplated, such as increasing or reducing the number of electrodes in the layouts or making the electrodes in the layouts wider or thinner than depicted (note that the layouts of FIGS. 3, 4, 5A-C, and 6A-B are not drawn to scale). The layouts of FIGS. 3, 4, 5A-C, and 6A-B may be formed using transparent or highly transmissive material, such as ITO or an FLM mesh (e.g., where it is desired to have a high level of light transmission by the layout). For example, the layout depicted in FIG. 3 may be formed using longitudinal strips of FLM mesh separated by cuts along the x-axis and the y-axis. As another example, the layout depicted in FIG. 4 may be formed using longitudinal strips of FLM mesh separated by cuts along the y-axis. As yet another example, the layout depicted in FIG. 5A may be formed using a plane of FLM mesh with cuts to form a band of FLM mesh in the pattern depicted in FIG. 5A. In some embodiments, the layouts of FIGS. 3, 4, 5A-C, and 6A-B may be formed using a fully-filled metal conductor plane that is substantially opaque with cuts that create the patterns depicted in FIGS. 3, 4, 5A-C, and 6A-B.

FIG. 3 is an example layout with electrodes 300a-h and electrodes 302a-h. Electrodes 300ah are perpendicular to electrodes 302a-h. Electrodes 300ah are capacitively coupled to electrodes 302ah but not electrically coupled to electrodes 302a-h. Electrodes 300a-h may be arranged on one layer of a sensor while electrodes 302ah may be arranged on a different layer of the sensor. Dielectric material may be used to separate electrodes 300ah from electrodes 302a-h. For example, a sheet of dielectric material may be placed between the layer including electrodes 300ah and the layer includes electrodes 302a-h. As another example, dielectric material may be placed at the intersections of electrodes 300ah and 302a-h. Each of electrodes 300ah and 302ah in the layout depicted in FIG. 3 may be driven with the same or different signals (e.g., a pulse signal or a periodic signal); in the latter case, multiple drivers may be used. Each of electrodes 300ah and 302ah may be terminated at the same or different terminations. Example terminations that may be used are ground or a selected impedance load. In some embodiments, reflections caused by one or more touches (or caused by the proximity of one or more objects) of these driven signals may be detected on any of electrodes 300ah and 302a-h. Receivers coupled to electrodes 300ah and 302ah may detect such reflections and this information may be used to determine, as discussed above, the location(s) of the touch(es) on any of the electrodes 300ah and 302a-h. Such locations may be used to determine coordinates of one or more touches (or the proximity of one or more objects). In some embodiments, coordinates of one or more touches may be determined without needing to determine where a disturbance that caused a reflection occurred on any of electrodes 300ah and 302a-h. For example, detecting a reflection on electrodes 300a and a reflection on electrodes 302b may cause coordinates corresponding to the intersection of electrodes 300a and 302b to be determined. In some embodiments, the layout depicted in FIG. 3 may allow for increased accuracy in touch detection. In some embodiments, the speed at which touches may be detected may also be improved because electrodes 300ah and 302ah may be driven and sensed for reflections simultaneously

If reflections are detected on more than one of electrodes 300ah and/or more than one of electrodes 302a-h, then, in some embodiments, the electrodes associated with the largest reflections will be determined and a touch will be determined as occurring at the coordinates of those electrodes. For example, if reflections were detected at electrodes 300a-c and 302a-c, it may be determined that the electrodes with the largest reflections occurred at electrodes 300a and 302a. In such an example, a touch may be determined to have occurred at the coordinates corresponding to the intersection of electrodes 300a and 302a.

Timing information regarding reflections detected on electrodes 300ah and electrodes 302ah may be used to determine the coordinates of a touch. For example, if a touch was determined to have occurred at or near the intersection of electrodes 300b and 302g, then the time information associated with the reflections that occurred along electrodes 300b and 302g may be used to further refine the x- and y-coordinates associated with the touch. In this example, the timing of the reflection detected on electrodes 300b may be used to further refine the y-coordinate associated with the touch by determining where along the electrodes 300b the reflection originated from. Similarly, the timing of the reflection detected on electrodes 302g may be used to further refine the x-coordinate associated with the touch by determining where along the electrodes 302g the reflection originated from.

In some embodiments, interpolation may be used in determining coordinates associated with a touch. For example, reflections may be detected on electrodes 300d-f. The amplitude of the reflection on electrode 300e may be larger than electrodes 300d and 300f and the reflection on electrode 300f may have a larger amplitude than electrode 300d. Interpolation may be used to determine a coordinate of the touch that is situated between electrodes 300e and 300f but closer to electrode 300e according to existing techniques.

FIG. 4 is an example layout with electrodes 400-409. Electrodes 400-409 are parallel to one another. Electrodes 400-409 may be arranged on a single layer of a sensor. Each of electrodes 400-409 in the layout depicted in FIG. 4 may be driven with the same or different signals (e.g., a pulse signal or a periodic signal). Each of electrodes 400-409 may be terminated at the same or different terminations. Example terminations that may be used are ground or a selected impedance load. In some embodiments, reflections caused by one or more touches (or caused by the proximity of one or more objects) of these driven signals may be detected on any of electrodes 400-409. As discussed above, the location of the touch on any of the electrodes 400-409 that caused the reflection may be determined. Such locations may be used to determine coordinates of one or more touches (or the proximity of one or more objects). For example, the presence of a reflection on electrodes 400 may indicate a x-coordinate for a touch that caused the reflection. The location of the origin of the reflection along electrodes 400 may indicate a y-coordinate for the touch that caused the reflection. This location may be determined using timing information associated with the reflection. In some embodiments, the layout depicted in FIG. 4 may allow for increased accuracy in touch detection. Multiple touches may be detected using similar techniques. In some embodiments, the speed at which touches may be detected may also be improved because electrodes 400-409 may be driven and sensed for reflections simultaneously. Also, fewer electrodes may need to be driven as compared to FIG. 3 which may lead to faster detection of touches.

If reflections are detected on more than one of electrodes 400-409, then, in some embodiments, the electrodes associated with the largest reflections will be determined and a touch will be determined to be used to determine the coordinates of the touch. For example, if reflections were detected at electrodes 400 and 401, it may be determined that electrodes 400 had a larger reflection than the reflection at electrodes 401. In such an example, electrodes 400 may be used to determine the coordinates of the touch.

Reflections that occur on more than one of electrodes 400-409 may be used to determine the x-coordinate of a touch, in some embodiments. For example, if a reflection was detected on electrodes 402 and electrodes 403, then these reflection signals may be compared to each other. Interpolation may be performed to determine an x-coordinate that corresponds to a position between electrodes 402 and 403.

FIGS. 5A-C illustrate example electrode layouts that may be used in a touch sensor in accordance with the teachings discussed above in FIGS. 1-2 to determine the location of touches (or the proximity of an object) detected by the touch sensor. In FIG. 5A, electrodes 500 are arranged as a space filling curve. In FIG. 5B, electrodes 502 are arranged in a square spiral pattern (other types of spiral patterns may be used, such as curved spirals). In FIG. 5C, electrodes 504 are arranged in a curve that resembles a square function (other periodic curves may be used, such as sinusoidal-like curves). Each of electrodes 500, 502, and 504 may be arranged on a single layer of a touch sensor. Each of electrodes 500, 502, and 504 may be terminated at ground or at a selected impedance load. In operation, in some embodiments, electrodes 500 may be driven with a signal (e.g., a pulse signal or a periodic signal). In some embodiments, reflections caused by one or more touches (or caused by the proximity of one or more objects) of the driven signals may be detected using electrodes 500. As discussed above, the location of the touch within electrodes 500 that caused the reflection may be determined. This location may be used to determine coordinates of one or more touches (or the proximity of one or more objects) due to the shape of electrodes 500. For example, data may be stored (e.g., in a table) that correlates reflection times to coordinates on the sensor. In such an example, the timing information regarding a reflection may be used to look up the coordinates of an associated touch in the stored data. Similar steps may be performed on electrodes 502 and 504 when they are used in the touch sensor. In some embodiments, the layout depicted in FIGS. 5A-C may allow for increased accuracy in touch detection. Multiple touches may be detected using techniques similar to those discussed above. In some embodiments, the speed at which touches may be detected may also be improved because the electrodes of FIGS. 5A-C may be driven and sensed for reflections. Also, fewer electrodes may need to be driven as compared to FIGS. 3 and 4 which may lead to faster detection of touches using the example layouts depicted in FIGS. 5A-C. The layouts of FIGS. 5A-C may allow for a single driver and a single receiver to be used. While the layouts depicted in FIGS. 5A-C depict electrodes arranged using straight lines and corners, some embodiments may use curved edges instead of lines and/or may use curves instead of corners. This may be advantageous in that it may reduce challenges in sending signals along paths that include corners, such as reflections.

FIGS. 6A-B illustrate example electrode layouts using more than one, substantially parallel electrodes that may be used in a touch sensor in accordance with the teachings discussed above in FIGS. 1-2 to determine the location of touches (or the proximity of an object) detected by the touch sensor. In FIG. 6A, layout 600 includes two, substantially parallel electrodes: electrodes 610 and 620. At one end, electrodes 610 and 620 may be co-terminated or they may be grounded. At the other end, electrodes 610 and 620 may be coupled to signal transceiving circuitry (e.g., controller 12 of FIG. 1). As an example, when detecting a touch, electrode 610 may be driven with a signal while electrode 620 is not driven. Electrodes 610 and 620 may be measured after electrode 610 is driven. The measurement from electrode 620 (which may represent noise present in the system) may be subtracted from the measurement from electrode 610. Then, one or more of the techniques discussed above with respect to FIGS. 1-5 may be applied to the resulting calculation to determine the location of a touch or the proximity of an object to the touch sensor using detected reflections. This may be advantageous in that the effect of noise may be reduced when attempting to detect touches using reflections on driven electrodes.

In FIG. 6B, layout 650 includes electrodes 660, ground line 670, and electrodes 680 arranged substantially parallel to each other. Electrodes 680 are terminated to ground line 670. Electrodes 660 are not electrically coupled to electrodes 680. When detecting the location of a touch or the proximity of an object, for example, a drive signal may be provided to electrodes 660 but not electrodes 680. The discussion of FIG. 2 above, especially at step 200, provides embodiments of how driving electrodes 660 may be performed. Afterwards, measurements of electrodes 660 and 680 may be taken. The measurement of electrodes 680 may be subtracted from the measurement of electrodes 660. In some embodiments, this subtraction may compensate for noise and result in fewer errors. The signal resulting from the subtraction is then analyzed to determine if it includes one or more reflections. The discussion of FIG. 2 above, especially at step 210, provides embodiments of how reflection(s) may be detected. As discussed above with respect to FIGS. 1, 2, and 5A-C, the location of the touch within electrodes 660 that caused the reflection(s) may be determined. This location may be used to determine coordinates of one or more touches (or the proximity of one or more objects) due to the shape of electrodes 660. For example, data may be stored (e.g., in a table) that correlates reflection times to coordinates on the sensor. In such an example, the timing information regarding a reflection may be used to look up the coordinates of an associated touch in the stored data. The presence of ground line 670 may be advantageous in that it may provide electrical and capacitive separation between electrodes 660 and 680. For example, the effect on electrodes 680 of electrodes 660 being driven due to capacitive coupling between electrodes 660 and 680 may be reduced or eliminated due to ground line 670 being arranged between electrodes 660 and 680.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A method, performed by executing logic embodied by one or more computer readable non-transitory storage media, comprising:
sending a first signal on a first line of a touch sensor, the first line comprising a first plurality of electrodes;
taking a first measurement of the first line, the first measurement comprising a reflection of the first signal on the first line of the touch sensor, the reflection of the first signal resulting from a change in impedance of the first line at a first location on the first line, the reflection of the first signal traveling, in a direction different than the first signal;
taking a second measurement of a first portion of a second line, the second line adjacent to and substantially parallel to a third line, the third line situated between the first line and the second line, the third line adjacent to and substantially parallel to the first line, a first portion of the third line coupled to ground, a second portion of the third line coupled to a second portion of the second line;
determining a difference between the first measurement and the second measurement;
analyzing timing parameters associated with the first signal and the difference between the first measurement and the second measurement;
determining the first location on the first line in response to analyzing the timing parameters; and
determining coordinates of a touch on a device comprising the touch sensor in response to determining the first location on the first line.

2. The method of claim 1, further comprising:
sending a second signal on a fourth line of the touch sensor, the fourth line comprising a second plurality of electrodes;
receiving a reflection of the second signal on the fourth line of the touch sensor, the reflection of the second signal resulting from a change in impedance of the fourth line at a second location on the fourth fine, the reflection of the second signal traveling in a direction different than the fourth signal;
analyzing second timing parameters associated with when the second signal was sent and When the reflection of the second signal was received;
determining the second location on the fourth line in response to analyzing the second timing parameters; and
wherein determining coordinates of the touch comprises determining coordinates of the touch in response to determining the first location on the first line and determining the second location on the fourth line.

3. The method of claim 2, wherein sending the second signal on the fourth line of the touch sensor comprises sending the second signal on the fourth line of the touch sensor at substantially the same time as sending the first signal on the first line of the touch sensor.

4. The method of claim 2, wherein the first line is aligned along a first axis and the fourth line is aligned along a second axis, the first and second axes being different.

5. The method of claim 1, wherein analyzing the timing parameters comprises comparing the time when the first signal was sent to the time when the reflection of the first signal was measured.

6. The method of claim 1, further comprising:
determining a magnitude associated with the difference between the first measurement and the second measurement; and
wherein determining the coordinates of the touch comprises determining the coordinates of the touch in response to determining the magnitude.

7. (canceled)

8. A system comprising:
a touch sensor comprising:
a first line, the first line comprising a first plurality of electrodes;
a second line; and
a third line the second line adjacent to and substantially parallel to the, third line, the third line situated between the first line and the second line, the third line adjacent to and substantially parallel to the first line, a first portion of the third line coupled to ground, a second portion of the third line coupled to a first portion of the second line:
one or more computer-readable non-transitory storage media comprising logic that, when executed, is operable to:
send a first signal on the first line of the touch sensor;
take a first measurement of the first line, the first measurement comprising a reflection of the first signal on the first line of the touch sensor, the reflection of the first signal resulting from a change in impedance of the first line at a first location on the first line, the reflection of the first signal traveling in a direction different than the first signal;
take a second measurement of a second portion of the second line;
determine a difference between the first measurement and the second measurement;
analyze timing parameters associated with the first signal and the difference between the first measurement and the second measurement;
determine the first location on the first line in response to analyzing the timing parameters; and
determine coordinates of a touch on the system in response to determining the first location on the first line.

9. The system of claim 8, wherein:
the touch sensor comprises a fourth line of the touch sensor, the fourth line comprising a second plurality of electrodes;
the logic is further operable to:
send a second signal on the fourth line of the touch sensor;
receive a reflection of the second signal on the fourth line of the touch sensor, the reflection of the second signal resulting from a change in impedance of the fourth line at a second location on the fourth line, the reflection of the second signal traveling in a direction different than the second signal;
analyze second timing parameters associated with when the second signal was sent and when the reflection of the second signal was received;
determine the second location on the fourth line in response to analyzing the second timing parameters; and
determine the coordinates of the touch by determining coordinates of the touch in response to determining the first location on the first line and determining the second location on the fourth line.

10. The system of claim 9, wherein the logic is operable to send the second signal on the fourth line of the touch sensor by sending the second signal on the fourth line of the touch sensor at substantially the same time as sending the first signal on the first line of the touch sensor.

11. The system of claim 9, wherein the first line is aligned along a first axis and the fourth line is aligned along a second axis, the first and second axes being different.

12. The system of claim 8, wherein the logic is operable to analyze the timing parameters by comparing the time when the first signal was sent to the time when the reflection of the first signal was measured.

13. The system of claim 8, wherein the logic is further operable to:
determine a magnitude associated with the difference between the first measurement and the second measurement; and
wherein the logic operable to determine the coordinates of the touch comprises logic operable to determine the coordinates of the touch in response to determining the magnitude.

14. (canceled)

15. One or more computer-readable non-transitory storage media comprising logic that, when executed, is operable to:
send a first signal on a first line of a touch sensor, the first line comprising a first plurality of electrodes;
take a first measurement of the first line, the first measurement comprising a reflection of the first signal on the first line of the touch sensor, the reflection of the first signal resulting from a change in impedance of the first line at a first location on the first the reflection of the first signal traveling in a direction different than the first signal;
take a second measurement of a first portion of second line, the second line adjacent to and substantially parallel to a third line, the third line situated between the first line and the second line, the third line to and substantially parallel to the first line, a first portion of the third line coupled to ground, a second portion of the third line coupled to a second portion the second lines;
determine a difference between the first measurement and the second measurement;
analyze timing parameters associated with the first signal and the difference between the first measurement and the second measurement;
determine the first location on. the first line in response to analyzing the timing parameters; and
determine coordinates of a touch on a device comprising the touch sensor in response to determining the first location on the first line.

16. The media of claim 15, wherein:
the logic is further operable to:
send a second signal on a fourth line of the touch sensor, the fourth line comprising a second plurality of electrodes;
receive a reflection of the second signal on the fourth line of the touch sensor, the reflection of the second signal resenting from a change in impedance of the fourth line at a second location on the fourth line, the reflection of the second signal traveling in a direction different than the second signal;
analyze second timing parameters associated with when the second signal was sent and when the reflection of the second signal was received;
determine the second location on the fourth line in response to analyzing the second timing parameters; and
determine the coordinates of the touch by determining coordinates of the touch in response to determining the first location on the first line and determining the second location on the fourth line.

17. The media of claim 16, wherein the logic is operable to send the second signal on the fourth line of the touch sensor by sending the second signal on the fourth line of the touch sensor at substantially the same time as sending the first signal on the first line of the touch sensor.

18. The media of claim 16, wherein the first line is aligned along a first axis and the fourth line is aligned along a second axis, the first and second axes being different.

19. The media of claim 15, wherein the logic. is operable to analyze the timing parameters by comparing the time when the first signal was sent to the time when the reflection of the first signal was measured.

20. The media of claim 15, wherein the logic is further operable to:
determine a magnitude associated with the difference between the first measurement and the second measurement; and
wherein the logic operable to determine the coordinates of the touch comprises logic operable to determine the coordinates of the touch in response to determining the magnitude.

21. (canceled)
